(19) United States
(12) Patent Application Publication
(10) Pub. No.: US 2010/0267503 A1
(43) Pub. Date: Oct. 21, 2010

(54) HYDRAULIC TENSIONING ELEMENT FOR A TRACTION MECHANISM DRIVE

(75) Inventors: Bernd Hartmann, Weisendorf (DE); Werner Petri, Erlangen (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/665,457

(22) PCT Filed: May 29, 2008
(86) PCT No.: PCT/EP2008/056578

§ 371 Date: Jun. 22, 2010

(30) Foreign Application Priority Data
Jun. 20, 2007 (DE) 10 2007 028 189.9

(51) Int. Cl. F16H 7/08

(52) U.S. Cl. 474/110

(57) ABSTRACT

A hydraulic tensioning element for a traction mechanism drive, which has a cylinder, an axially movable piston guided in the cylinder, a spring element disposed between the cylinder and the piston, a pressure chamber configured in the cylinder, a storage chamber configured in the piston for a hydraulic fluid, and a valve enabling an exchange of the hydraulic fluid between the pressure chamber and the storage chamber as a function of an actuating movement of the piston. The piston and the cylinder are configured such that the damping generated by the piston movement is substantially independent of the temperature.

### FIELD OF THE INVENTION

The invention relates to a hydraulic tensioning element for a traction mechanism drive, having a cylinder, an axially movable piston guided in the cylinder, a spring element arranged between the cylinder and the piston, a pressure chamber formed in the cylinder and a reservoir chamber for a hydraulic fluid formed in the piston, and a valve enabling an exchange of the hydraulic fluid between the pressure chamber and the reservoir chamber as a function of an adjusting movement of the piston.

### BACKGROUND OF THE INVENTION

Hydraulic tensioning elements are used in traction mechanism drives for internal combustion engines and serve for tensioning a traction mechanism, for example a belt or a chain. The tensioning element comprises a cylinder, which is embodied as a fixed and pivotally arranged housing part, together with a piston, which is directly or indirectly connected to a tensioning pulley, between which a spring means is arranged. The spring means may be embodied as a spiral compression spring.

DE 10 2004 047 450 A1 discloses such a hydraulic tensioning element. As the piston rod is displaced in relation to the cylinder, a volume of hydraulic fluid is exchanged between a pressure chamber in the cylinder and a reservoir chamber in the piston, the direction of flow varying as a function of the adjusting movement of the piston rod. When the piston rod is displaced in the direction of the pressure chamber, hydraulic fluid can escape via a leakage gap occurring between the piston rod and the cylinder liner into the reservoir chamber. In the case of an adjusting movement of the piston in the opposite direction, hydraulic fluid flows from the reservoir chamber via a valve arranged in the base of the reservoir chamber into the pressure chamber.

In such tensioning elements the damping is produced by the hydraulic fluid, which has to pass through the leakage gap between the piston and the cylinder, which acts as a laminar gap. One disadvantage, however, is that the damping varies as a function of the viscosity of the hydraulic fluid and thereby of the operating temperature.

### SUMMARY OF THE INVENTION

The object of the invention is to specify a hydraulic tensioning element, which will ensure adequate damping under all operating conditions.

According to the invention, in a hydraulic tensioning element of the aforementioned type, this object is achieved in that the piston and the cylinder are designed so that the damping produced by the piston movement is substantially independent of the temperature.

Various measures can be used to achieve this effect. According to a first embodiment of the invention the piston may be sealed in relation to the cylinder and may have a restrictor element formed separately from the valve. In this case the damping may be defined by the form of the restrictor element. The restrictor element can preferably be embodied as a restriction bore, which is formed separately from the valve bore. It is also possible for the restrictor element to be embodied as an orifice, preferably having an inserted ring. In this variant the main flow of the hydraulic fluid flows through the restrictor element or the restriction bore; only a small proportion of the hydraulic fluid flows through the gap between the piston and the cylinder.

According to an alternative development of the invention the piston may have a radial edge extending over at least a part of the piston circumference. This edge can preferably be arranged in the area of the maximum diameter of the piston and acts as a restrictor element, which serves to produce the desired damping. The edge may also extend merely over a part of the circumference of the piston, so as not to impair the guidance of the piston in the cylinder.

According to a further alternative development of the invention, the tensioning element may have a restrictor element associated with the piston and/or valve in the area of the valve. In this variant the restrictor element is not formed separately from the valve but is incorporated into the valve or the piston. The restrictor element may take the form of a recess or groove, which preferably runs radially. The desired damping effect can also be obtained if the valve is embodied as a plate valve having a restrictor element, which may comprise a spring, if applicable.

According to a preferred development of the invention, at least one outside edge of the piston may be rounded, so as to produce a shape conducive to the flow.

It is also possible to form a leakage gap and an annular space for the hydraulic fluid between the inner face of the cylinder and the outside of the piston and to connect the annular space to the reservoir chamber in the piston via at least one fluid conduit. The damping characteristic can also be influenced by the shape and size of the fluid conduit.

### BRIEF DESCRIPTION OF THE DRAWINGS

Further advantages and details of the invention are described below on the basis of exemplary embodiments and with reference to the figures. The figures are schematic representations, of which:

FIG. 1 shows a sectional, partial view of a first exemplary embodiment of a hydraulic tensioning element according to the invention;

FIG. 2 shows a sectional, partial view of a second exemplary embodiment of a hydraulic tensioning element according to the invention;

FIG. 3 shows an exemplary embodiment of a hydraulic tensioning element according to the invention with the piston running in;

FIG. 4 shows the tensioning element shown in FIG. 3 with the piston running out;

FIG. 5 shows a sectional, partial view of a hydraulic tensioning element in which the piston has a radially running edge;

FIG. 6 shows an enlarged view of the valve area of a hydraulic tensioning element according to the invention; and

FIG. 7 shows the valve area of a hydraulic tensioning element according to the invention having a plate valve.

### DETAILED DESCRIPTION OF THE DRAWINGS

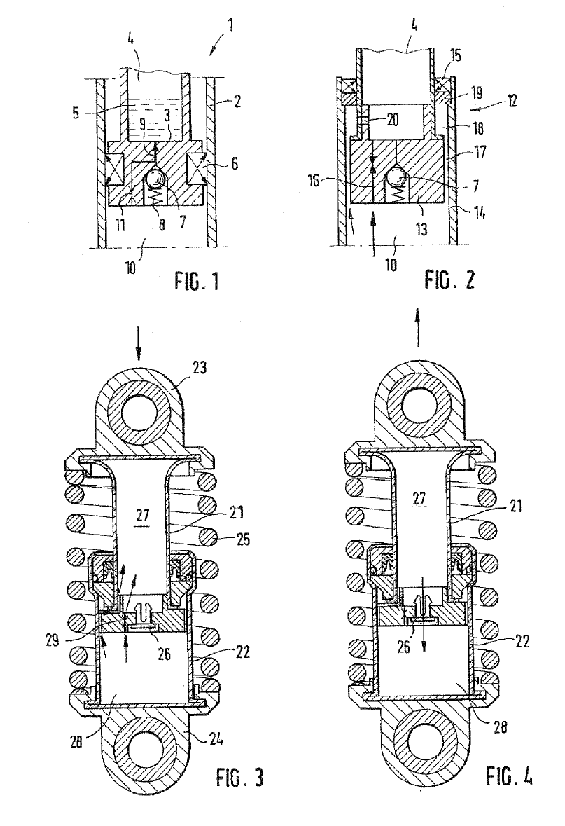

FIG. 1 shows a sectional partial view of the main components of a hydraulic tensioning element 1. A piston 3 is movable inside a cylinder 2. A reservoir chamber 4 for a hydraulic fluid 5 is situated inside the piston 3. A piston seal 6, which seals the piston 3 in relation to the cylinder 2, is situated at the outer circumference of the piston 3. A ball valve 7, loaded by a spring 6, connects the reservoir chamber 4 to a pressure chamber 10 via a fluid conduit 9. A restrictor element in the form of a restriction bore 11 is arranged in the piston 3 in parallel with the ball valve 7. The restriction bore 11 is formed separately from the ball valve 7, so that the flow of hydraulic fluid is independent from the position of the valve. Even when the ball valve 7 is closed, hydraulic fluid 4 can flow via the fluid port 9 as the piston 3 runs into the cylinder 2. The piston seal 6 causes only a small quantity of hydraulic fluid to be situated between the inside wall of the cylinder 2 and the circumferential surface of the piston 3 in order to lubricate these contact zones. As the piston 3 runs out, hydraulic fluid 5 flows from the pressure chamber 10 into the reservoir chamber 4. The main oil flow at the same time flows via the restriction bore 11 and the fluid conduit 9 to the reservoir chamber 4, as is symbolically indicated by the arrow; only a negligibly small quantity of the hydraulic fluid 5 passes via the piston seal 6 into the reservoir chamber 4. Unlike conventional hydraulic tensioning elements, the damping effect is not obtained via a laminar gap but via the restriction bore 11. The damping therefore is substantially independent of the temperature.

FIG. 2 shows a second exemplary embodiment of a hydraulic tensioning element. FIG. 2 represents a sectional, partial view of the main components of the tensioning element 12. The sealing between the piston 13 and the cylinder 14 is achieved, as in the first exemplary embodiment, by a piston seal 15. A restriction bore 16 connects the reservoir chamber 4 to the pressure chamber 10. The restriction bore 16 here is formed separately from the ball valve 7. A leakage gap 17 for the hydraulic fluid is formed between the inside of the cylinder 14 and the circumferential surface of the piston 13. As the piston 13 runs into the cylinder 14 when the piston 13 shown in FIG. 2 is moved downward, the main flow of the hydraulic fluid flows from the pressure chamber 10 into the reservoir chamber 4 via the restriction bore 16; a secondary flow flows via the leakage gap 17 into the annular space 18. The annular space 18 is formed on one side by the outer face of the piston 13, the annular space 18 also being defined by a sealing element 19 and the inner face of the cylinder 14. The annular space 18 is connected via a fluid conduit 20 to the reservoir chamber 4, so that when the piston 13 runs in hydraulic fluid passes via the leakage gap 17, the annular space 18 and the fluid conduit 20 into the reservoir chamber 4.

FIG. 3 shows an exemplary embodiment of a hydraulic tensioning element with the piston running in; FIG. 4 shows the hydraulic tensioning element shown in FIG. 3 with the piston running out. A fastening eye 23, 24 is fitted to the piston 21 and to the cylinder 22, respectively in order to fasten the hydraulic tensioning element to the housing of an internal combustion engine or to a unit. A compression spring 25 encloses the piston 21 and the cylinder 22. A valve in the form of a plate valve 26 opens and closes a conduit between a reservoir chamber 27 in the piston 21 and a pressure chamber 28 in the cylinder 22. A restriction bore 29, formed separately from the plate valve 26, is situated in the piston 21.

When the piston 21 is pressed into the cylinder 22, as is indicated by the downward pointing arrow in FIG. 3, hydraulic fluid flows out of the pressure chamber 28 into the reservoir chamber 27 via the restriction bore 29. In addition to this main oil flow a comparatively small fraction of the hydraulic fluid flows through a leakage gap formed between the piston 21 and the cylinder 22.

FIG. 4 shows the hydraulic tensioning element shown in FIG. 3 with the piston 21 running out of the cylinder 22. A negative pressure, which causes the plate valve 26 to open, is produced in the pressure chamber 28. When the plate valve 26 is opened, hydraulic fluid can flow from the reservoir chamber 27 into the pressure chamber 28.

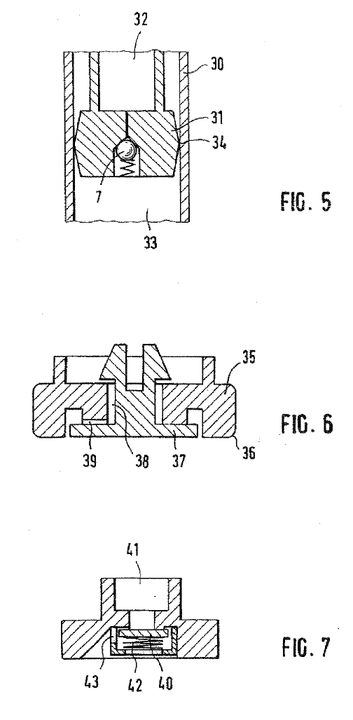

FIG. 5 shows a partial view of the main components of a further exemplary embodiment of a hydraulic tensioning element. A piston 31, which separates a reservoir chamber 32 from a pressure chamber 33, is guided in a cylinder 30. The reservoir chamber 32 and the pressure chamber 33 are separated from one another by a ball valve 7. The piston 31 has a circumferential edge 34 at its outer circumference. In other exemplary embodiments the edge may be formed merely over a part of the circumference. A defined leakage gap, through which hydraulic fluid flows, is formed between the edge 34 and the inside of the cylinder 30. The damping produced by the circumferential edge 34 is substantially independent of the temperature.

FIG. 6 shows the valve area of a hydraulic tensioning element on a larger scale. The section of a piston 35 shown in FIG. 6 has rounded outside edges 36. The valve 37, incorporated in the piston 35, is embodied as a plate valve, which has the capacity for limited vertical movement. FIG. 6 shows the plate valve in the opened state. This state exists when the piston is drawn out of the cylinder. In the process a negative pressure is produced in the pressure chamber, causing the valve 37 to assume the position shown in FIG. 6. Hydraulic fluid can then flow from the reservoir chamber through the gap 38 formed between the valve and the piston and a radial restriction groove 39 on the valve side into the pressure chamber. In other embodiments multiple, separate restriction grooves may also be provided.

FIG. 7 shows the valve area of a further exemplary embodiment of a hydraulic tensioning element. The section of the valve area of the tensioning element shown in FIG. 7 comprises a plate valve 40, which opens and closes a fluid conduit 41, and which is acted upon by a spring element 42. The plate valve 40 has a radial recess 43, which acts as restrictor element and brings about the requisite damping of the flow of hydraulic fluid and hence damping of the piston movement.

### REFERENCE NUMERALS

1 Tensioning element
2 Cylinder
3 Piston
4 Reservoir chamber
5 Hydraulic fluid
6 Piston seal
7 Ball valve
8 Spring
9 Fluid conduit
10 Pressure chamber
11 Restriction bore
12 Tensioning element
13 Piston
14 Cylinder
15 Piston seal
16 Restriction bore
17 Leakage gap
18 Annular space
19 Sealing element
20 Fluid conduit
21 Piston
22 Cylinder
23 Fastening eye
24 Fastening eye
25 Compression spring
26 Plate valve
27 Reservoir chamber
28 Pressure chamber
29 Restriction bore
30 Cylinder
31 Piston
32 Reservoir chamber
33 Pressure chamber
34 Edge
35 Piston
36 Outside edge
37 Valve
38 Gap
39 Restriction groove
40 Plate valve
41 Fluid conduit
42 Spring element
43 Recess

1. A hydraulic tensioning element for a traction mechanism drive, comprising:
a cylinder;
an axially movable piston guided in the cylinder;
a spring element disposed between the cylinder and the piston;
a pressure chamber formed in the cylinder;
a reservoir chamber for a hydraulic fluid formed in the piston; and
a valve enabling an exchange of the hydraulic fluid between the pressure chamber and the reservoir chamber as a function of an adjusting movement of the piston,
wherein each piston and each cylinder are designed so that damping produced by the piston movement is substantially independent of temperature.

2. The tensioning element of claim 1, wherein the piston is sealed in relation to the cylinder and has a restrictor element formed separately from the valve.

3. The tensioning element of claim 2, wherein the restrictor element is a restriction bore.

4. The tensioning element of claim 2, wherein the restrictor element is an orifice and has an inserted ring.

5. The tensioning element of claim 1, wherein the piston has a radial edge extending over at least a part of the piston circumference.

6. The tensioning element of claim 5, wherein the edge is arranged in an area of a maximum diameter of the piston.

7. The tensioning element of claim 1, wherein the tensioning element has a restrictor element associated with the piston and/or valve in an area of the valve.

8. The tensioning element of claim 7, wherein the restrictor element is a radially running recess or groove.

9. The tensioning element of claim 7, wherein the valve is a plate valve, which may comprise a spring.

10. The tensioning element of claim 1, wherein at least one outside edge of the piston is rounded.

11. The tensioning element of claim 1, wherein a leakage gap and an annular space for the hydraulic fluid are formed between an inner face of the cylinder and an outside of the piston and the annular space is connected to the reservoir chamber in the piston via at least one fluid conduit.
